(19) United States
(12) Patent Application Publication
(10) Pub. No.: US 2016/0214312 A1
(43) Pub. Date: Jul. 28, 2016

(54) IMPRINT APPARATUS AND METHOD OF MANUFACTURING ARTICLE

(71) Applicant: CANON KABUSHIKI KAISHA, Tokyo (JP)

(72) Inventor: Shinichi Hirano, Utsunomiya-shi (JP)

(21) Appl. No.: 15/002,178

(22) Filed: Jan. 20, 2016

(30) Foreign Application Priority Data
Jan. 23, 2015 (JP) 2015-011624

(51) Int. Cl. B29C 59/02

(52) U.S. Cl. CPC B29C 59/02; B29L 2007/001

(57) ABSTRACT

An imprint apparatus for forming a pattern in an imprint material on a substrate with a mold includes a storage unit configured to store information about the position of a first area having on its surface a relief pattern on the substrate, a determination unit configured to determine, in accordance with the information about the position of the first area stored in the storage unit and information about the position of a second area based on a recipe for the substrate, whether the first area overlaps the second area, and an avoidance unit configured to perform a process for avoiding pattern formation based on the recipe in the first area when the determination unit determines that the first area overlaps the second area.

### BACKGROUND OF THE INVENTION

1. Field of the Invention

The present invention relates to an imprint apparatus and a method of manufacturing an article using the same.

2. Description of the Related Art

An imprinting technique is to form a nanoscale pattern on a substrate. Attention is being given to an imprint apparatus based on this technique as a lithography apparatus for mass production of magnetic recording media or semiconductor devices. The imprint apparatus forms a pattern on a wafer by bringing an imprint material on the wafer into contact with a mold, curing the imprint material in contact with the mold, and separating the mold from the cured imprint material.

Japanese Patent Laid-Open No. 2012-146699 discloses an imprint apparatus that processes a wafer, on which a plurality of shot areas are defined, by applying resin to each of the shot areas, imprinting, or forming a pattern on the resin, and curing the resin.

In the above-described imprint apparatus, the resin is applied to each of the shot areas. While some of the shot areas on the wafer each have a formed pattern and the other shot areas have no pattern, an imprinting process on the wafer can be interrupted. After that, the imprinting process can be restarted.

For example, assuming that an error occurs in the apparatus during the imprinting process on a wafer, the wafer may be detached from a wafer stage for a recovery operation. Furthermore, for determination of conditions for mass production, predetermined areas on a wafer may be subjected to the imprinting process and the wafer may then be detached from the wafer stage and unloaded from the imprint apparatus so that the other areas will be subjected to the imprinting process later.

If a wafer partially subjected to the imprinting process is detached from the wafer stage as described above, a user has to store or record data indicating a state of the wafer. An increase in the amount of data to be stored may result in a heavy burden of data management on the user, leading to human error. Furthermore, molds for imprint apparatuses are expensive. If a pattern of a mold comes into contact with a pattern-formed area having on its surface a relief pattern, the mold may be broken.

### SUMMARY OF THE INVENTION

The present invention provides an imprint apparatus for forming a pattern in an imprint material on a substrate with a mold. The imprint apparatus includes a storage unit configured to store information about the position of a first area having on its surface a relief pattern on the substrate, a determination unit configured to determine, in accordance with the information about the position of the first area stored in the storage unit and information about the position of a second area based on a recipe for the substrate, whether the first area overlaps the second area, and an avoidance unit configured to perform a process for avoiding pattern formation based on the recipe in the first area when the determination unit determines that the first area overlaps the second area.

Further features of the present invention will become apparent from the following description of exemplary embodiments with reference to the attached drawings.

### BRIEF DESCRIPTION OF THE DRAWINGS

FIG. 1 is a schematic diagram illustrating an exemplary configuration of an imprint apparatus according to an embodiment and illustrates an imprint mechanism of the imprint apparatus and its surroundings.

FIG. 2 is a schematic diagram illustrating an exemplary configuration of the imprint apparatus and illustrates a carrier loading/unloading mechanism of the imprint apparatus and its surroundings.

FIG. 3 is a schematic diagram illustrating control blocks in a controller.

FIGS. 4A to 4D are diagrams illustrating information tables managed by the controller.

FIG. 5 is a diagram explaining the relationship between pattern-formed areas and pattern formation areas based on recipe information.

FIG. 6 is a flowchart of a process for avoiding pattern formation in a pattern-formed area.

FIG. 7 is a flowchart of a sub-process for skip data update.

FIG. 8 is a flowchart of a lot process by the imprint apparatus.

FIG. 9 is a schematic diagram illustrating an imprint apparatus according to a modification.

### DESCRIPTION OF THE EMBODIMENTS

Preferred embodiments of the present invention will be described with reference to the attached drawings. In the figures, the same components are designated by the same reference numerals and redundant description is avoided.

### Embodiments

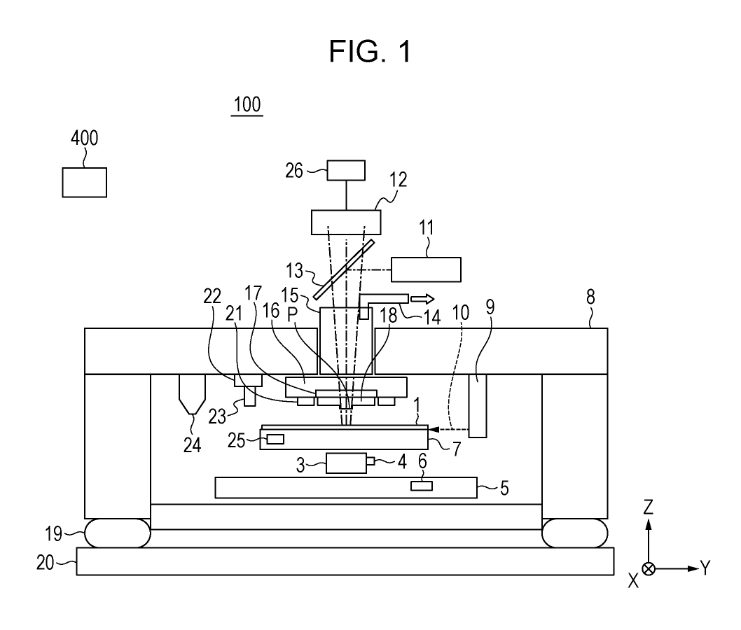

FIG. 1 is a schematic diagram illustrating an exemplary configuration of an imprint apparatus 100 according to an embodiment and illustrates an imprint mechanism of the imprint apparatus 100 and its surroundings. The imprint apparatus 100, which is a lithography apparatus, brings a mold 18 having a pattern into contact with an imprint material on a substrate 1 to form the pattern in the imprint material on the substrate 1. In the present embodiment, resin is used as an imprint material and a photo-curing method for curing resin by irradiation with ultraviolet rays (UV light) is used. The imprint apparatus 100 supplies the resin to the substrate 1 and cures the resin in contact with (a pattern face of) the mold, thus forming a pattern on the substrate 1. The imprint apparatus 100 may cure resin by irradiation with light in other wavelength ranges or with another energy. For example, the imprint apparatus 100 may use a heat-curing method for curing resin with heat. In the present embodiment, the substrate 1 is a circular silicon wafer. The substrate 1 may be made of another material or may have another shape. In the present embodiment, the mold 18 is made of quartz and has a relief pattern in a raised face (pattern face P) thereof. The relief pattern corresponds to a pattern to be formed on the substrate 1. The mold may be made of another material or may have another shape. In the following description, the term “Z axis or direction” refers to the direction identical to the optical axis of UV light applied to the resin on the substrate, and the terms “X axis or direction” and “Y axis or direction” refer to the directions orthogonal to each other in a plane perpendicular to the Z axis.

The imprint apparatus 100 includes a measuring device 4, a measuring device 6, a substrate stage 7, a bridge structure 8, a measuring device 9, a light source 11, an alignment measuring unit 12, a half mirror 13, an exhaust duct 14, a connecting member 15, and a mold head 16. The imprint apparatus 100 further includes a mold chuck 17, an air spring 19, a base 20, a gas supply unit 21, a holder 22, a resin supply unit 23, an off-axis scope 24, a pressure sensor 25, a signal processor 26, and a controller 400.

The mold chuck 17 holds the mold 18 by, for example, vacuum suction. The mold chuck 17 may have a structure for preventing the mold 18 from dropping off from the mold chuck 17. In the present embodiment, the mold chuck 17 is tightly coupled to the mold head 16. The mold chuck 17, accordingly, can be regarded as part of the mold head 16 or can be regarded as a member coupled to the mold chuck 17. The mold head 16 includes a mechanism that is movable (driven) in at least three axial directions, Z, ωX, and ωY directions, relative to the bridge structure 8.

The mold head 16 is supported by the connecting member 15 and the bridge structure 8. Like the mold head 16, the alignment measuring unit 12 is also supported by the bridge structure 8.

The alignment measuring unit 12 performs alignment measurement to align the mold 18 with the substrate 1. In the present embodiment, the alignment measuring unit 12 includes an alignment detection system for detecting a mark on the mold 18 and a mark on the substrate stage 7 or the substrate 1 to generate an alignment signal. The alignment measuring unit 12 may include a camera. The alignment measuring unit 12 may have a function of observing or checking a curing state (imprint state) of the resin on the substrate 1 irradiated with UV light applied via the half mirror 13 disposed above the connecting member 15. In this case, the alignment measuring unit 12 can observe not only the curing state of the resin on the substrate 1 but also the extent to which the resin on the substrate 1 is imprinted with the mold 18, the extent to which recessed part of the pattern of the mold 18 is filled with the resin on the substrate 1, and the extent to which the mold 18 is released from the cured resin on the substrate 1.

Light emitted from the light source 11 is reflected by the half mirror 13, passes through the mold 18, and is applied to the resin on the substrate 1. The resin on the substrate 1 is cured by irradiation with the light from the light source 11.

The bridge structure 8 is supported by the base 20 such that the air spring 19 for floor vibration isolation is interposed between the bridge structure 8 and the base 20. The air spring 19 has a structure used as an active image-stabilizing function typically included in an exposure apparatus. For example, the air spring 19 includes XYZ relative position measurement sensors attached to the bridge structure 8 and the base 20, XYZ driving linear motors, and a servo valve controlling the volume of air inside the air spring.

The resin supply unit (dispenser) 23 having nozzles for supplying or applying resin to the substrate 1 is attached to the bridge structure 8 such that the holder 22 is interposed between the resin supply unit 23 and the bridge structure 8. The resin supply unit 23 supplies resin droplets to the substrate 1 to form a line of droplets with an inkjet head for an inkjet printer. Moving or scanning the substrate stage 7 (i.e., the substrate 1) while supplying the resin from the resin supply unit 23 to the substrate 1 enables the resin to be applied to a rectangular area on the substrate 1. A typical inkjet head in an inkjet printer has a function of controlling the discharge of ink from fine nozzles arranged linearly and the conveyance of a recording sheet to draw an image and/or letters. An area on the substrate 1 to which resin is applied does not have to have a rectangular shape. The resin supply unit 23 of the imprint apparatus 100 may supply resin to an area having any shape (for example, a circular or sector shape).

In the present embodiment, the substrate 1 has a circular shape. In defining rectangular shot areas on the substrate 1, therefore, shot areas on the periphery of the substrate 1 protrude from (the periphery of) the substrate 1 and the shapes of these shot areas are not rectangular. These shot areas are called “partial shot areas”. Under present circumstances, a plurality of chips can be formed in one shot area of 33×26 mm. For efficient formation of chips on the substrate 1, a pattern has to be formed in each partial shot area. The terms “pattern formation area and “pattern-formed area”, which will be described later, as used herein refer not only to total shot areas but also to partial shot areas.

In the imprint apparatus 100, a film (residual film) is left in recessed part of a relief pattern formed on the substrate 1. The residual film has to be etched. The residual film has a thickness, called “residual layer thickness (RLT)”. If a film having a thickness equivalent to the RLT is not formed in the shot areas, the substrate 1 would be damaged by etching. The application of resin to the periphery of the substrate 1, or the partial shot areas is effective in preventing such damage. In this case, if the resin supply unit 23 applies resin in a rectangular form, the resin would protrude from the substrate 1. If the substrate 1 in such a state is irradiated with light from the light source 11, the resin would be cured and fixed to a holding surface (for example, a substrate chuck of the substrate stage 7) for holding the substrate 1. The substrate 1 would be bonded to the holding surface. Additionally, another substrate 1 to be subsequently subjected to an imprinting process would be held on the holding surface with contamination (cured resin) therebetween, resulting in a reduction in surface accuracy of the substrate 1. A correct pattern may fail to be formed. In the present embodiment, the resin is applied to a proper area on the substrate 1 by controlling the resin discharge of the resin supply unit 23 and the movement of the substrate stage 7.

The substrate stage 7 holds the substrate 1 with, for example, the substrate chuck. The substrate stage 7 includes a mechanism that is movable (driven) in six axial directions, X, Y, Z, ωX, ωY, and ωZ directions. In the present embodiment, the substrate stage 7 is supported by the bridge structure 8 via an X slider 3 including a moving mechanism for movement in the X direction and a Y slider 5 including a moving mechanism for movement in the Y direction. The measuring device 4 for measuring the position of the X slider 3 relative to the Y slider 5 is attached to the X slider 3. The measuring device 6 for measuring the position of the Y slider 5 relative to the bridge structure 8 is attached to the Y slider 5. In other words, the measuring devices 4 and 6 measure the position of the substrate stage 7 relative to the bridge structure 8. In the present embodiment, the measuring devices 4 and 6 each include an encoder (linear encoder).

The distance between the substrate stage 7 and the bridge structure 8 in the Z direction is determined by the bridge structure 8, the X slider 3, and the Y slider 5. The stiffness of each of the X slider 3 and the Y slider 5 in the Z direction and that in a tilt direction are maintained at substantially several tens of nanometers/N (newton), so that fluctuations of the position of the substrate stage 7 in the Z direction relative to the bridge structure 8 during an imprinting operation can be suppressed to several tens of nanometers.

The measuring device 9 is attached to the bridge structure 8. In the present embodiment, the measuring device 9 includes an interferometer. The measuring device 9 applies measurement light 10 to the substrate stage 7 and detects the measurement light 10 reflected by an interferometer mirror disposed at an edge of the substrate stage 7, thereby measuring the position of the substrate stage 7. The position of the substrate stage 7 is measured by the measuring device 9 disposed closer to the holding surface, on which the substrate 1 is held, of the substrate stage 7 than the measuring devices 4 and 6. Although the measurement light 10 applied to the substrate stage 7 by the measuring device 9 is illustrated as a single beam in FIG. 1, the measuring device 9 is capable of measuring at least the position of the substrate stage 7 in the X direction, that in the Y direction, the amount of rotation of the substrate stage 7, and the amount of tilt of the substrate stage 7.

The gas supply unit 21 supplies filling gas to a region in the vicinity of the mold 18, specifically, to the space between the mold 18 and the substrate 1 to increase the degree of filling of the recessed part of the pattern of the mold 18 with resin. The filling gas contains at least one of penetrable gas and condensable gas to rapidly reduce the filling gas (bubbles) sandwiched between the mold 18 and the resin and promote filling of the recessed part of the pattern of the mold 18 with the resin. The term “penetrable gas” as used herein refers to a gas that has high penetrability to the mold 18 and penetrates through the mold 18 while the resin on the substrate is being pressed (i.e., being molded) by the mold 18. The term “condensable gas” as used herein refers to a gas that liquefies (condenses) while the resin on the substrate is being pressed (i.e., being molded) by the mold 18.

The off-axis scope 24 detects a reference mark on a reference plate placed on the substrate stage 7 without via the mold 18. The off-axis scope 24 can also detect a mark on (each of the shot areas of) the substrate 1.

The pressure sensor 25, which is attached to the substrate stage 7 in the present embodiment, detects a pressure that acts on the substrate stage 7 when the mold 18 is pressed against the resin on the substrate. The pressure sensor 25 functions as a sensor that detects a state of contact of the resin on the substrate with the mold 18 by detecting a pressure acting on the substrate stage 7. The pressure sensor 25 may be attached to the mold head 16. The pressure sensor 25 may be attached to at least one of the mold head 16 and the substrate stage 7.

The controller 400 includes a circuit board on which a central processing unit (CPU or processor) and a memory are mounted. The controller 400 controls the imprinting operation of the imprint apparatus 100 and operations associated with the imprinting operation. The controller 400 may include a plurality of circuit boards, which may be arranged on a control rack (not illustrated) of the imprint apparatus 100. The controller 400 will be described in detail later.

The gas supply unit 21 supplies the filling gas to the space between the mold 18 and the substrate 1 during the imprinting process as described above. The filling gas supplied to the space between the mold 18 and the substrate 1 is sucked upward through the mold head 16 and is discharged through the exhaust duct 14 to the outside of the imprint apparatus 100. The filling gas supplied to the space between the mold 18 and the substrate 1 may be recovered by a gas recovery mechanism (not illustrated) instead of being discharged to the outside of the imprint apparatus 100.

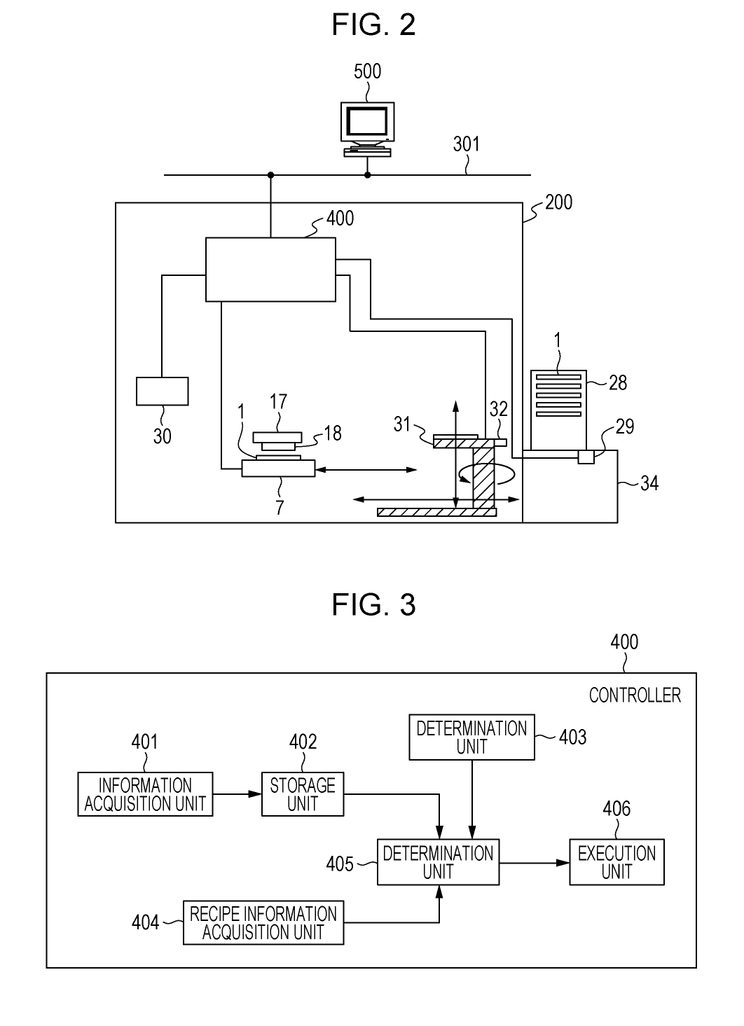

FIG. 2 is a schematic diagram illustrating an exemplary configuration of the imprint apparatus 100 and illustrates a carrier loading/unloading mechanism 34 of the imprint apparatus 100 and its surroundings. The imprint apparatus 100 includes a chamber 200 and the carrier loading/unloading mechanism 34. The chamber 200 accommodates a plurality of components (e.g., the substrate stage 7 and the bridge structure 8) of the imprint apparatus 100. The chamber 200 is used to adjust the temperature and humidity of an imprint environment and reduce the entry of foreign substances. The imprint apparatus 100 (the controller 400) is connected to a computer (host computer) 500 disposed outside the chamber 200 via a network 301.

A carrier 28 is a container used for loading the substrate 1 into the chamber 200. The carrier 28 accommodates a plurality of substrates. In the present embodiment, the carrier 28 is a front-opening unified pod (FOUP). A tag (identifier) in which carrier identification information is stored is attached to (or provided on) the carrier 28. The carrier 28 has a plurality of slots (not illustrated). The substrate 1 can be placed in any slot.

A reading unit 29 has a function of reading information in the tag attached to the carrier 28. The reading unit 29 transmits the read carrier identification information to the controller 400. A conveying robot 31 pulls the substrate 1 out of the carrier 28 and delivers the substrate 1 to the substrate stage 7. Two or more conveying robots 31 may be arranged to share tasks such that, for example, one conveying robot 31 delivers the substrate 1 to the substrate stage 7 and another conveying robot 31 receives the substrate 1 from the substrate stage 7. The substrate stage 7 is movable close to the conveying robot 31 when the substrate 1 is delivered to the conveying robot 31. The conveying robot 31 includes a rotating mechanism, a vertical moving function, a horizontal moving function, and a telescopic hand tool.

A user interface 30 functions as a display unit for displaying a state of the apparatus and an input unit for inputting information to the apparatus. The user interface 30 includes a keyboard (input device) and a display (display device).

A detecting unit 32 has a function of detecting the presence or absence of a substrate 1 at the level of each of the slots of the carrier 28. The detecting unit 32 may be aligned with the level of each slot in any way, for example, by moving the conveying robot 31 up or down or by moving the carrier 28 up or down.

FIG. 3 is a schematic diagram illustrating control blocks in the controller 400 in FIG. 1. An information acquisition unit (input unit) 401 has functions of acquiring information about the position of a pattern-formed area on a substrate and storing the information as a pattern-formed area information table to a storage unit 402. The term “pattern-formed area as used herein refers to an area (first area) having on its surface a relief pattern. The information about the position of a pattern-formed area on a substrate acquired by the information acquisition unit 401 is acquired through, for example, the user interface 30. The information about the position of a pattern-formed area on a substrate may be generated inside the controller 400. In this case, the information may be acquired without via the user interface 30. To generate the information inside the controller 400, the imprint apparatus performs the imprinting process and stores information indicative of the position of an area subjected to the imprinting process. The information may be acquired externally via the network 301. The information acquisition unit 401 has functions of acquiring information about a carrier and storing the information as a carrier management information table and a carrier process history information table to the storage unit 402. The information about the carrier acquired by the information acquisition unit 401 is acquired through the reading unit 29 and the detecting unit 32.

A determination unit 403 determines, in accordance with the carrier process history information table stored in the storage unit 402, the carrier management information table acquired from a newly loaded carrier, and information from the detecting unit 32, whether substrates accommodated in the loaded carrier are processing targets.

A recipe information acquisition unit 404 has functions of acquiring (extracting) information about the position of a recipe-based pattern formation area (second area), storing the acquired information as a pattern formation area information table, and transferring the information to a determination unit 405. The term “recipe-based pattern formation area” as used herein refers to an area specified (designated) to be subjected to pattern formation based on a recipe. A place where the pattern formation area information table is stored is not limited to the recipe information acquisition unit 404.

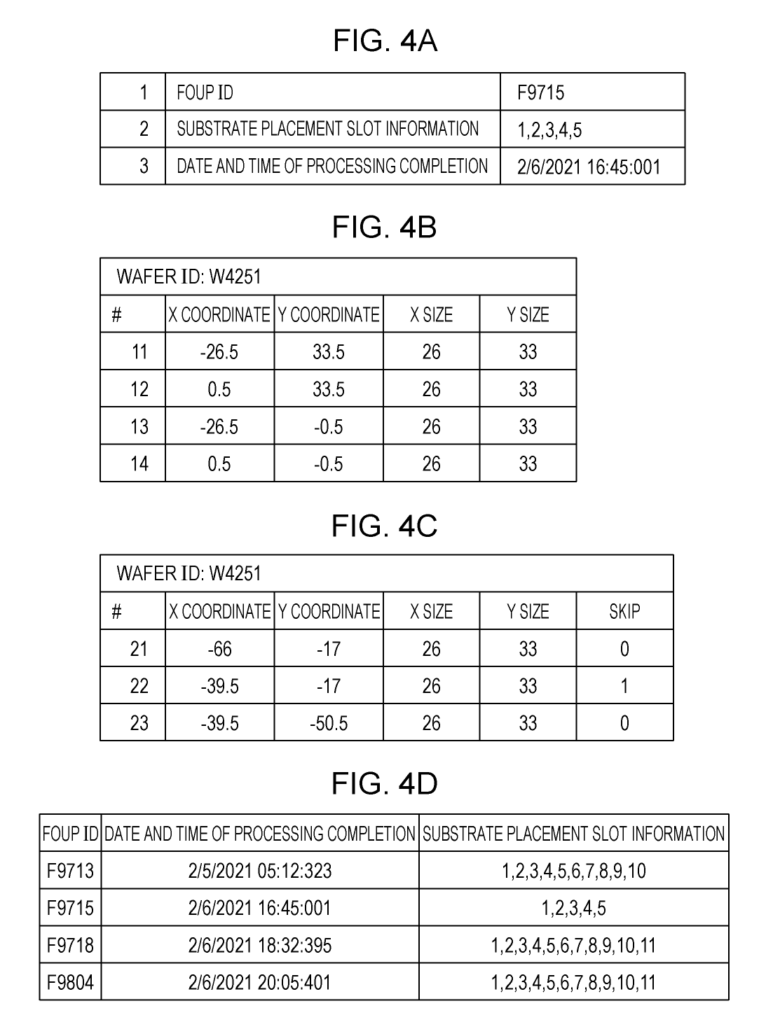

The determination unit 405 has functions of determining, in accordance with the information about the position of a pattern-formed area stored in the storage unit 402 and the information about the position of a pattern formation area acquired by the recipe information acquisition unit 404, whether the pattern-formed area overlaps the recipe-based pattern formation area on a substrate. When determining that the areas overlap, the determination unit 405 transfers avoidance information (an information table of FIG. 4C, which will be described later) to an execution unit 406. The execution unit 406 executes a pattern formation process based on the avoidance information. In the present embodiment, the determination unit 405 and the execution unit 406 function as an avoidance unit that performs a process for avoiding recipe-based pattern formation in a pattern-formed area. The avoidance unit may achieve the avoidance in another way. For example, the avoidance unit may issue a warning or a notice through the user interface 30 to achieve the avoidance.

FIG. 4A illustrates the carrier management information table for management of information about the carrier 28. The table contains first to third items of information. The first item is carrier identification information (FOUP ID) for identifying the carrier 28. In the present embodiment, stored information indicates “F9715”. The carrier identification information is acquired by reading the tag attached to the carrier 28 through the reading unit 29. The second item is substrate placement slot information. In the present embodiment, stored information indicates “1, 2, 3, 4, 5”. The substrate placement slot information is acquired by detecting the presence or absence of a substrate in each of the slots of the carrier 28 through the detecting unit 32. In the present embodiment, the substrates are present in slots numbered 1, 2, 3, 4, and 5 and there is no substrate in the other slots. The third item is the date and time of processing completion, specifically, information (process date-and-time information) indicative of the date and time when processing on the last substrate of substrates accommodated in the carrier 28 was completed. This information is acquired together with carrier identification information. The process date-and-time information is typically initialized when new substrates are placed into the carrier. This information is held until the substrates are exchanged.

FIG. 4B illustrates the pattern-formed area information table managed by the storage unit 402. The head of this table is a place used to store substrate identification information (wafer ID). In the present embodiment, stored information indicates “W4251”. An information field contains first to fifth items of information. The first item “#” represents area numbers in the order of storage. The second item “X coordinate” represents the X coordinates of upper left ends of shot areas each having on its surface a relief pattern. The third item “Y coordinate” represents the Y coordinates of the upper left ends of the shot areas each having the relief pattern on the surface. The fourth item “X size” represents the length in the X direction of each shot area having the relief pattern on the surface. The fifth item “Y size” represents the length in the Y direction of each shot area having the relief pattern on the surface. The pattern-formed area information table is managed on a substrate-by-substrate basis. Substrate identification information items corresponding one-to-one to substrates are stored such that each of the substrate identification information items is associated with the corresponding information indicating the above-described positions.

FIG. 4C illustrates the pattern formation area information table including information about the positions of pattern formation areas acquired from a recipe for a processing target substrate. The head of this table is a place used to store substrate identification information (wafer ID) of the processing target substrate. The stored substrate identification information indicates “W4251”. An information field contains first to sixth items of information. The first item “#” represents area numbers in the order of storage. The second item “X coordinate” represents the X coordinates of upper left ends (black circles) of shot areas to be subjected to imprinting (pattern formation). The third item “Y coordinate” represents the Y coordinates of the upper left ends (black circles) of the shot areas to be subjected to imprinting. The fourth item “X size” represents the length in the X direction of each shot area to be subjected to imprinting. The fifth item “Y size” represents the length in the Y direction of each shot area to be subjected to imprinting. The sixth item “skip” represents information indicating whether a target shot area designated by a recipe is actually subjected to imprinting. Information “0” indicates imprinting. Information “1” indicates that the shot area is not subjected to imprinting and is skipped. Although the pattern formation area information table is stored in the recipe information acquisition unit 404, this table may be stored in, for example, the storage unit 402.

FIG. 4D illustrates the carrier process history information table for management of process histories of a plurality of carriers. The table contains first to third items of information. The first item is carrier identification information. The second item is the data and time of processing completion. The third item is substrate placement slot information. The carrier process history information table is obtained by accumulating a plurality of carrier management information tables acquired in the past. Carriers having the same carrier identification information but associated with different process date-and-time information items are managed as different carriers. The carrier process history information table further contains substrate identification information (not illustrated) associated with slot numbers.

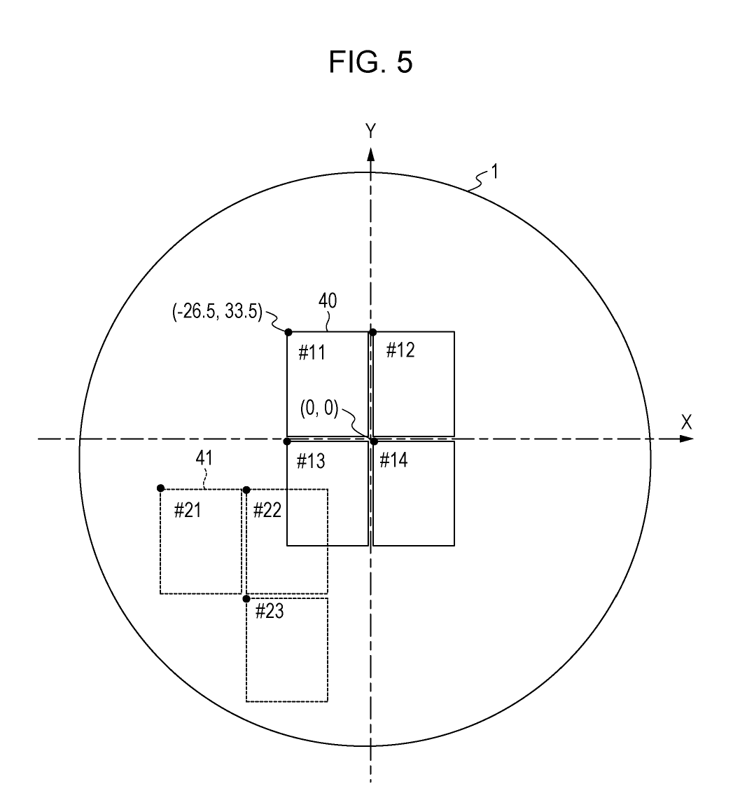

FIG. 5 is a diagram explaining the positional relationship between pattern-formed areas and recipe-based pattern formation areas. Four rectangular areas (#11, #12, #13, and #14), defined by solid lines, correspond to pattern-formed areas 40 formed on the substrate 1. Three rectangular areas (#21, #22, and #23), defined by dotted lines, correspond to recipe-based pattern formation areas 41. As seen from FIG. 5, the pattern-formed area #13 overlaps the recipe-based pattern formation area #22.

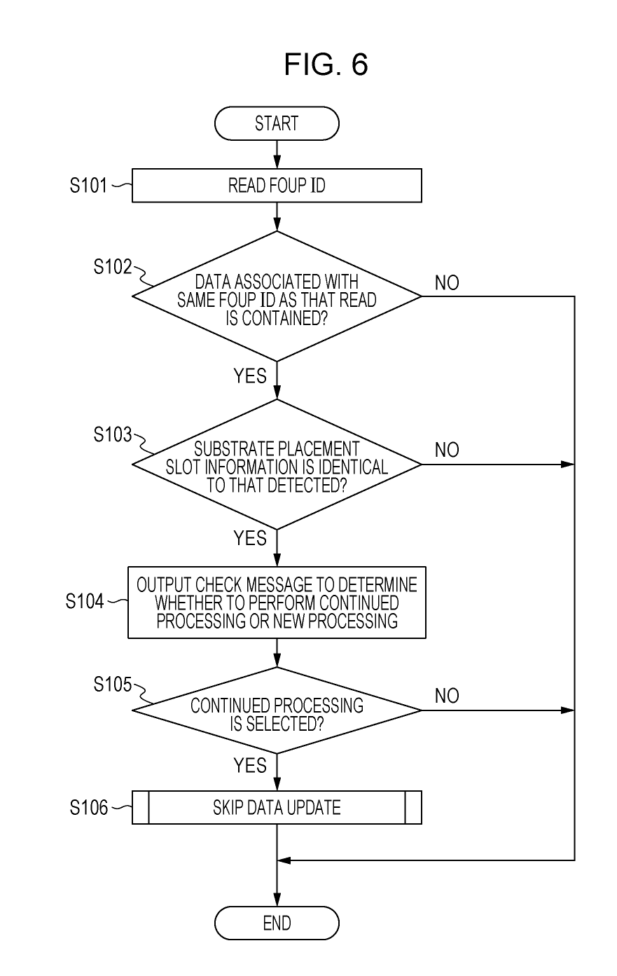

FIG. 6 is a flowchart of a process for avoiding pattern formation in a pattern-formed area. This process is performed by the above-described imprint apparatus.

In S101, information “FOUP ID” is read by the reading unit 29 and is stored into the carrier management information table.

In S102, whether a process history associated with the same FOUP ID as that read in S101 is contained in the carrier process history information table is determined. If YES, the process proceeds to S103. If NO, the process is terminated. If the carrier process history information table contains data items associated with the same FOUP ID, the determination may be made based on the data associated with the latest date and time of processing completion.

In S103, whether substrate placement slot information associated with the same FOUP ID in the carrier process history information table is identical in the date and time of processing completion to substrate placement slot information detected by the detecting unit 32 is determined. If YES, the process proceeds to S104. If NO, the process is terminated.

In S104, the user interface 30 outputs a check screen (check message) to prompt a user to determine whether substrates accommodated in the carrier 28 loaded in the apparatus are to be subjected to new processing or a continued imprinting process (continued processing). If the user intends to restart the imprinting process on a substrate on which the imprinting process has been interrupted (i.e., a substrate having a pattern-formed area), the user selects “YES” to perform the continued imprinting process. If the substrates accommodated in the carrier 28 are new substrates to be subjected to processing, the user selects “NO”.

In S105, whether the continued imprinting process is selected is determined based on the result of input in S104. If YES, the process proceeds to S106. If NO, the process is terminated. If a user determination is not needed, processing in S105 may be omitted.

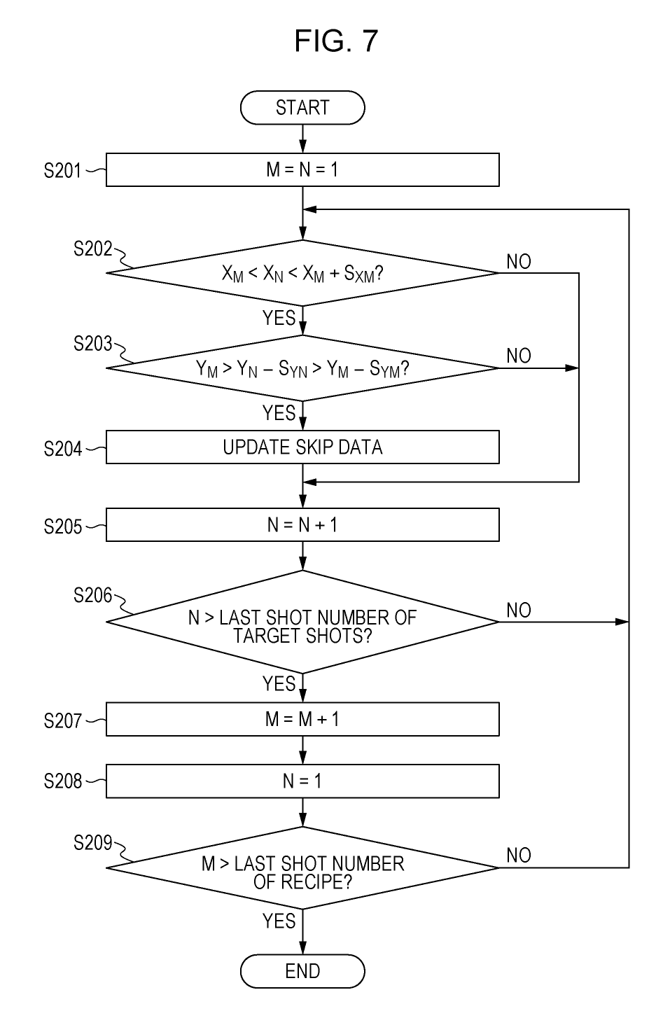

In S106, skip data is updated. Update processing includes comparison between the pattern-formed area information table and the pattern formation area information table to determine whether pattern-formed areas overlap pattern formation areas. If the areas overlap, skip data associated with the shot in the pattern formation area information table is updated to 1. If the areas do not overlap, update processing is not performed and an initial value of 0 is left unchanged. This processing is performed by the determination unit 405. The processing will be described in detail with reference to FIG. 7.

FIG. 7 is a flowchart of a sub-process for skip data update in FIG. 6.

In S201, a counter variable N indicating the shot number of a substrate to be processed and a counter variable M indicating the shot number of a recipe used for determination are initialized to 1.

In S202, whether Expression 1 and Expression 2 hold simultaneously is determined. If YES, the sub-process proceeds to S203. If NO, the sub-process proceeds to S205.

X_{M}<X_{N} (1)

X_{N}<X_{M}+S_{XM} (2)

where X_{M} denotes the X coordinate of the Mth shot of the recipe, X_{N} denotes the X coordinate of the Nth shot (corresponding to a pattern-formed area) of the substrate, and S_{XM} denotes the dimension in the X direction of the Mth shot of the recipe.

In S203, whether Expression 3 and Expression 4 hold simultaneously is determined. If YES, the sub-process proceeds to S204. If NO, the sub-process proceeds to S205.

Y_{M}>Y_{N}−S_{YN} (3)

Y_{N}S_{YN}>Y_{M}−S_{YM} (4)

where Y_{M} denotes the Y coordinate of the Mth shot of the recipe, Y_{N} denotes the Y coordinate of the Nth shot (corresponding to the pattern-formed area) of the substrate, and S_{YM} denotes the dimension in the Y direction of the Mth shot of the recipe.

A case where Expressions 1 to 4 hold simultaneously means that the pattern-formed area overlaps a recipe-based (stored) pattern formation area.

In S204, skip data associated with the shot in the pattern formation area information table is updated to 1.

In S205, 1 is added to the counter variable N, thus being ready to shift to determination about the next target shot.

In S206, whether all of target shots are subjected to the overlap determination is determined. Specifically, whether the counter variable N is greater than the last shot number of the target shots is determined. If YES, the sub-process proceeds to S207. If the counter variable N is equal to or less than the last shot number of the target shots, the sub-process is returned to S202.

In S207, 1 is added to the counter variable M, thus being ready to shift to determination about the next shot of the recipe.

In S208, the counter variable N indicating the shot number of a substrate to be processed is initialized to 1.

In S209, whether all of shots of the recipe are subjected to the overlap determination is determined. Specifically, whether the counter variable M is greater than the last shot number of the shots of the recipe is determined. If YES, the sub-process is terminated. If the counter variable M is equal to or less than the last shot number of the shots of the recipe, the sub-process is returned to S202.

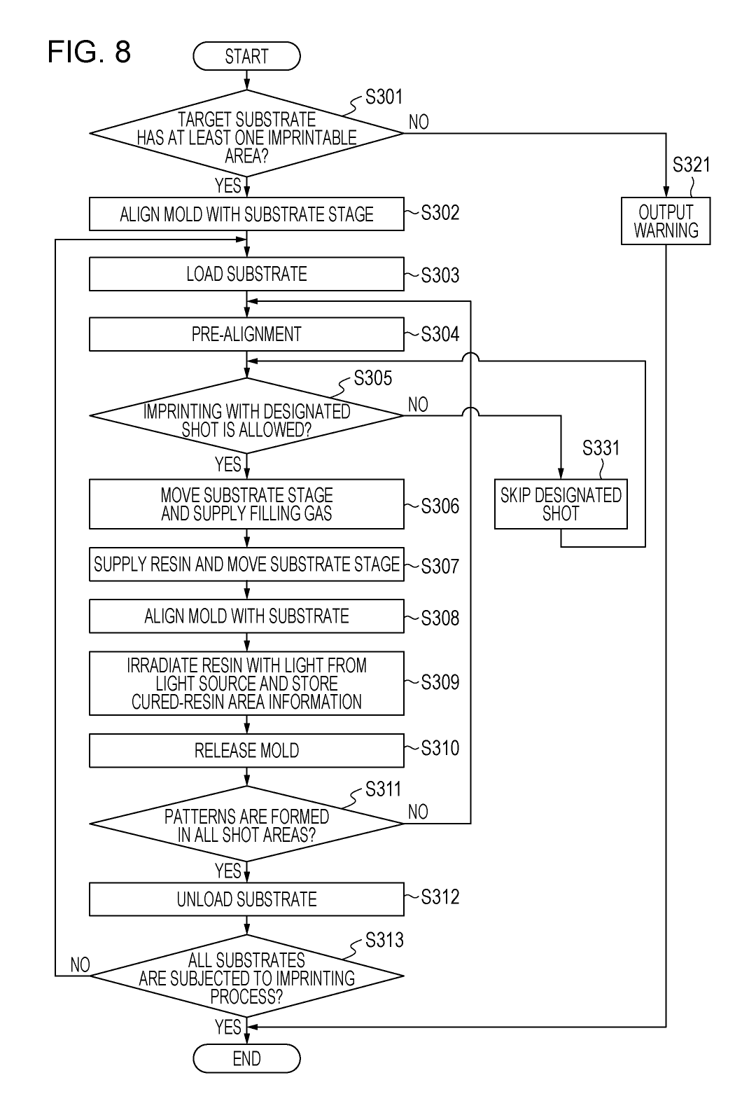

FIG. 8 is a flowchart of a lot process by the imprint apparatus 100 according to the present embodiment.

In S301, whether a target substrate to be processed has at least one imprintable area is determined. For this determination, skip data in the pattern formation area information table of FIG. 4C is used. If YES, the process proceeds to S302. If NO, the process proceeds to S321.

In S321, a warning indicating that there is no shot with which imprinting is allowed in a designated recipe is output to the user interface 30. The warning is transmitted to the computer 500 via the network 301.

In S302, the controller 400 aligns the mold 18 with the substrate stage 7 based on a result of alignment measurement by the alignment measuring unit 12. Before the alignment, the mold 18 is conveyed into the imprint apparatus 100 by a mold conveying system (not illustrated) and is held by the mold chuck 17. A mark (alignment mark) to be detected by the alignment measuring unit 12 may be placed as a dedicated reference mark on the substrate stage 7 or may be placed on a dedicated alignment substrate.

In S303, a substrate 1 is loaded into the imprint apparatus 100 by the conveying robot 31 and is then held by the substrate stage 7 (the substrate chuck). In other words, the substrate 1 is fixed to the substrate stage 7.

In S304, the controller 400 performs pre-alignment (PA). The pre-alignment may be performed once upon exchanging a substrate. Specifically, the substrate stage 7 is moved to a space under the off-axis scope 24 and the position of the substrate 1 held by the substrate stage 7 is measured by the off-axis scope 24. In the pre-alignment, for example, a plurality of marks arranged on the substrate 1 are detected, thereby measuring the position of the substrate 1 in a rotation direction. The pre-alignment may be performed with such accuracy (approximately 1 μm to approximately 2 μm) that alignment marks arranged on shot areas of the substrate 1 will be located within a measurement range of the alignment measuring unit 12 in alignment (S308) of the mold 18 with the substrate 1.

In S305, whether imprinting with a shot designated in the recipe is allowed is determined. If YES, the process proceeds to S306. If NO, the process proceeds to S331. Whether imprinting with a shot designated in the recipe is allowed is determined based on skip data in the pattern formation area information table of FIG. 4C.

In S331, coordinate information indicating a destination of the substrate stage 7 stored in the controller 400 is rewritten so that the coordinate information indicates the coordinates of the next shot position.

In S306, the substrate stage 7 is moved so that a target shot area (to be subjected to the imprinting process) of the substrate 1 is positioned under the resin supply unit 23. In addition, the gas supply unit 21 supplies the filling gas to the space between the mold 18 and the substrate 1.

In S307, the resin supply unit 23 supplies the resin to the target shot area of the substrate 1. Specifically, the resin supply unit 23 supplies the resin to the target shot area of the substrate 1 positioned under the resin supply unit 23 in accordance with a predetermined coating pattern (drop pattern). After the target shot area of the substrate 1 is supplied with the resin, the substrate stage 7 is moved so that the target shot area is positioned under (the pattern face P of) the mold 18.

In S308, the controller 400 aligns the mold 18 with (the target shot area of) the substrate 1 based on a result of alignment measurement by the alignment measuring unit 12 while the resin on the substrate is in contact with the pattern face P of the mold 18. This alignment is called die-by-die alignment because the alignment is performed for each shot area (die) of the substrate 1. The alignment may be performed before the mold 18 contacts the resin on the substrate 1.

In S309, the controller 400 irradiates the resin on the target shot area of the substrate 1 with light from the light source 11 while the resin on the substrate is in contact with the pattern face P of the mold 18 (namely, such that the light passing through the mold 18 is applied to the resin on the substrate). In addition, information about the area with cured resin is stored in the pattern-formed area information table of FIG. 4B.

In S310, the mold head 16 is moved upward to separate or release the mold 18 from the resin cured on the target short area of the substrate 1. Thus, a resin pattern corresponding to the pattern face P of the mold 18 is left in the target shot area of the substrate 1 (namely, the pattern corresponding the pattern face P of the mold 18 is formed in the target shot area of the substrate 1). In releasing the mold 18, the mold head 16 is moved upward so that the resin pattern is not broken, specifically, shearing stress applied to the pattern face P of the mold 18 is equal to or less than breaking stress applied to the resin pattern.

In S311, the controller 400 determines whether patterns are formed in all of the imprintable shot areas of the substrate 1. If NO, the process is returned to S304 to form a pattern in the next target shot area. If YES, the process proceeds to S312.

In S312, the conveying robot 31 unloads the substrate 1 having the patterns formed in all of the shot areas from the imprint apparatus 100.

In S313, the controller 400 determines whether all of the substrates 1 are subjected to the imprinting process. If NO, the process is returned to S303 to perform the imprinting process on the next substrate 1. If YES, the process is terminated.

In the present embodiment, in S331, the coordinates of a target position of the substrate stage 7 is changed to avoid formation of a new pattern in a pattern-formed area in accordance with skip data.

Such an avoiding operation is not limited to processing in the above-described flowchart. For example, conveying a substrate to the substrate stage for pattern formation may be prevented or inhibited to avoid formation of a new pattern. Additionally, resin supply may be inhibited to avoid formation of a new pattern.

In the above-described embodiment, the substrate is unloaded from the imprint apparatus. The present invention can be applied to a case where a substrate is detached from the substrate stage (in other words, the substrate is located inside the imprint apparatus).

If pattern part of a mold is brought into contact with a pattern-formed area having a relief pattern on its surface, the mold may be broken. For example, if a substrate partially subjected to the imprinting process is detached from the substrate stage for recovery from an error state of the apparatus, or if a substrate partially subjected to the imprinting process is unloaded out of the imprint apparatus for condition determination, the user would have to store or record data indicating a state of the substrate and manage the data in order to restart the imprinting process on the substrate. Such management may cause human error. For trouble-free processing, the surface of a substrate could be inspected for a relief pattern by using an inspection device. Such inspection may reduce throughput. According to the present embodiment, the imprint apparatus manages a state of a substrate, determines the presence or absence of overlap, and performs the avoiding process when determining the presence of overlap. This enables a reduction in burden accompanied by management on the user.

### Modification

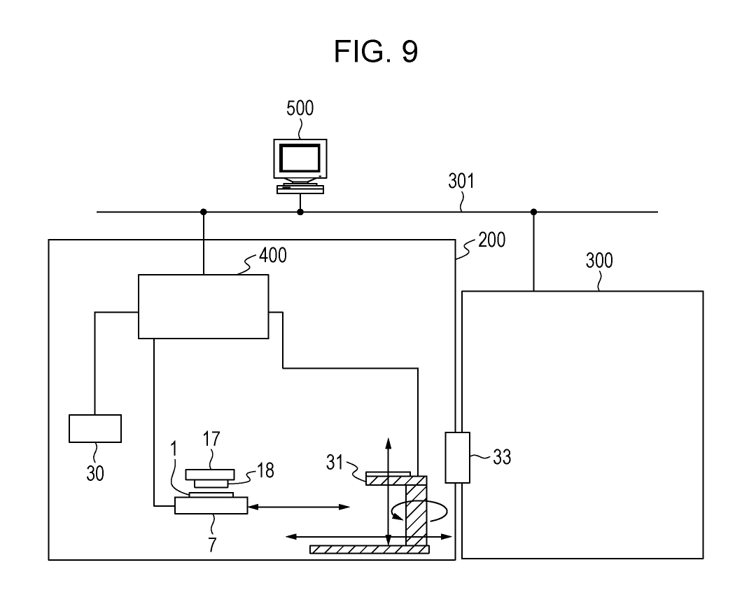

FIG. 9 is a schematic diagram illustrating a system according to a modification of the embodiment. The system includes the imprint apparatus of FIG. 1, the computer, a device including a substrate conveying mechanism, and a processing machine that are connected. In this modification, the processing machine, indicated at 300, forms a contact layer.

A transfer station 33 includes a first substrate placement unit used to place a substrate 1 on which a contact layer is formed by the processing machine 300 and a second substrate placement unit used to transfer a substrate 1 on which a resin pattern 27c is formed to the processing machine 300. The processing machine 300, which is connected to the imprint apparatus, has a function of processing the entire surface of an area having the formed resin pattern 27c.

The network 301 outside the apparatus is used for information transmission and reception as well as various applications. The controller 400 can use the network 301 to receive information from the processing machine 300.

In the system including the imprint apparatus with no carrier loading/unloading mechanism 34 and the processing machine 300 connected to each other, wafer ID common to the imprint apparatus and the processing machine 300 is used. A substrate is transferred between the imprint apparatus and the processing machine 300 via the transfer station 33 and information (signal) is transferred between them via the network 301. According to such a method, when a substrate has the same wafer ID as that of a substrate processed in the past, it can be determined that the substrate is to be subjected to the continued imprinting process, and when a substrate has different wafer ID from other substrates, it can be determined that the substrate is to be subjected to new processing.

When it is determined that a substrate is to be subjected to the continued imprinting process in the system including the imprint apparatus and the processing machine 300 connected to each other, the process of FIG. 7 can be used to update skip data. Similarly, the imprinting process on an overlapped area can be avoided based on updated skip data in accordance with the flowchart of FIG. 8.

### Method of Manufacturing Article

According to an embodiment of the present invention, a method of manufacturing an article, such as a device (e.g., a semiconductor integrated circuit element or a liquid crystal display element), includes transferring (forming) a pattern to a substrate (e.g., a wafer, a glass plate, or a film substrate) using the above-described imprint apparatus. The method may further include etching the substrate having the transferred pattern. To manufacture another article, such as a patterned medium (recording medium) or an optical element, the method may include processing the substrate having the transferred pattern instead of the etching.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-011624, Jan. 23, 2015, which is hereby incorporated by reference herein in its entirety.

What is claimed is:

1. An imprint apparatus for forming a pattern in an imprint material on a substrate with a mold, the apparatus comprising:
a storage unit configured to store information about a position of a first area on the substrate, the first area having a relief pattern on a surface of the first area;
a determination unit configured to determine, in accordance with the information about the position of the first area stored in the storage unit and information about a position of a second area based on a recipe for the substrate, whether the first area overlaps the second area; and
an avoidance unit configured to perform a process for avoiding pattern formation based on the recipe in the first area when the determination unit determines that the first area overlaps the second area.

2. The apparatus according to claim 1, wherein the storage unit stores substrate identification information items of a plurality of substrates such that the information about the position of the first area on each of the substrates is associated with the substrate identification information of the substrate.

3. The apparatus according to claim 1, wherein the storage unit stores carrier identification information for identifying a carrier accommodating a plurality of substrates and carrier process data-and-time information about the carrier such that the carrier identification information is associated with the carrier process date-and-time information.

4. The apparatus according to claim 3, further comprising:
a reading unit configured to read the carrier identification information from an identifier attached to the carrier accommodating the substrates,
wherein when the storage unit stores a process history of a carrier having the same carrier identification information as that read by the reading unit, the determination unit makes the determination on each of the substrates in the carrier.

5. The apparatus according to claim 3, wherein the storage unit stores carrier process date-and-time information generated by the imprint apparatus.

6. The apparatus according to claim 1, wherein the avoidance unit prevents a substrate from being conveyed to a stage for a pattern formation process to avoid the pattern formation.

7. The apparatus according to claim 1, wherein the avoidance unit prevents the imprint material from being applied to the first area to avoid the pattern formation.

8. A method of manufacturing an article, the method comprising:
forming a pattern in an imprint material on a substrate using an imprint apparatus; and
processing the substrate having the formed pattern,
wherein the imprint apparatus is configured to form a pattern in an imprint material on a substrate with a mold, and
wherein the imprint apparatus includes
a storage unit configured to store information about a position of a first area on the substrate, the first area having a relief pattern on a surface of the first area,
a determination unit configured to determine, in accordance with the information about the position of the first area stored in the storage unit and information about a position of a second area based on a recipe for the substrate, whether the first area overlaps the second area, and
an avoidance unit configured to perform a process for avoiding pattern formation based on the recipe in the first area when the determination unit determines that the first area overlaps the second area.
